(19) United States
(12) Patent Application Publication
(10) Pub. No.: US 2026/0183913 A1
(43) Pub. Date: Jul. 2, 2026

(54) NAIL GUN WITH WASHER POSITIONING STRUCTURE

(71) Applicant: EVERWIN PNEUMATIC CORPORATION, Taichung City (TW)

(72) Inventor: WEN-SHENG HUANG, TAICHUNG CITY (TW)

(21) Appl. No.: 19/006,609

(22) Filed: Dec. 31, 2024

(51) Int. Cl. B25C 1/00

(52) U.S. Cl. CPC B25C 1/001

(57) ABSTRACT

A nail gun with washer positioning structure includes a gun body having a firing part for firing a nail and located above an operation area, a conveyor device having a conveying member and a blocker, and a supporting member. The conveying member has a concave conveying groove. The conveying groove has a guidance supporting part convexly disposed on one end of the conveying groove. The guidance supporting part has a supporting section, and a guiding section disposed on one end away from the operation area. The blocker has two blocking parts between the washer in the operation area and the washer at the guidance supporting part. The supporting member is in the operation area, and has a position limiting groove concavely disposed on the bottom and defining a fixing position. The firing part fixes the nail and the washer in the operation area at the fixing position.

### BACKGROUND OF THE DISCLOSURE

### 1. Field of the Disclosure

The present disclosure relates to nail guns, and more particularly, to a nail gun with washer positioning structure.

### 2. Description of the Related Art

As disclosed by Taiwan utility model patent M515452, a nail gun with a chain-shaped washer cutting assistance function is disclosed, which mainly comprises a gun body, a nail magazine, and an automatic washer delivery mechanism. The aforementioned patent is able to concentrate the tensile stress for tearing the connection structure between washers onto the blade part formed at an end part of the abutting plate, allowing the washer next to the nailed washer to be easily broken from the nailed washer at the moment the nail is fired. However, in practical usage, when the disclosed blade part and the structure above are clamped together, the washer tends to warp upwards, so as to result in a misalignment, leading to the issue of the nail not being properly positioned at the center of the washer.

### SUMMARY OF THE DISCLOSURE

The present disclosure aims at resolving the issue of a conventional nail gun structure whose nail is unable to be accurately positioned at the center of the washer.

For achieving the aforementioned objectives, an embodiment of the present disclosure provides a nail gun with washer positioning structure, comprising:
a gun body having a firing part and located above an operation area, the firing part configured to fire a nail to the operation area;
a conveyor device configured to convey a plurality of washers to the operation area, the conveyor device having a conveying member and a blocker, the conveying member comprising a concave conveying groove, the washers placed in the conveying groove along a length direction of the conveying member, the conveying groove comprising a guidance supporting part convexly disposed along a height direction perpendicular to the length direction, the guidance supporting part disposed on one end of the conveying groove is adjacent to the operation area, the guidance supporting part having a supporting section protruding toward the operation area along the length direction, the guidance supporting part having a guiding section disposed on one end thereof away from the operation area, the blocker having two blocking parts positioned between the washer located in the operation area and the washer located at the guidance supporting part; and
a supporting member disposed in the operation area, the supporting member having a position limiting groove concavely disposed on a bottom part of the supporting member, the position limiting groove defining a fixing position, such that the firing part fixes the nail and the washer in the operation area at the fixing position.

With such configuration, through the connection relationship between the plurality of washers, the support provided by the supporting section, and the abutting relationship between the washer and the blocking part, the washer in the operation area is positioned in the operation area, preventing a positional displacement of components during the securing process of the washer and the to-be-secured object, thereby achieving the objective of the nail and the washer being accurately secured on the to-be-secured object.

### BRIEF DESCRIPTION OF THE DRAWINGS

FIG. 1 is a perspective view of the nail gun with washer positioning structure in accordance with an embodiment of the present disclosure.

FIG. 2 is a side view of the nail gun with washer positioning structure in accordance with an embodiment of the present disclosure.

FIG. 3 is a partially sectional side view of the nail gun with washer positioning structure in accordance with an embodiment of the present disclosure.

FIG. 4 is a front view of the nail gun with washer positioning structure in accordance with an embodiment of the present disclosure.

FIG. 5 is a partially sectional front view of the nail gun with washer positioning structure in accordance with an embodiment of the present disclosure.

FIG. 6 is a partial perspective view of the conveyor device of the nail gun with washer positioning structure in accordance with an embodiment of the present disclosure.

FIG. 7 is a partial top view and a partially enlarged view of the conveyor device of the nail gun with washer positioning structure in accordance with an embodiment of the present disclosure.

FIG. 8 is a top view of the conveying member of the nail gun with washer positioning structure in accordance with an embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

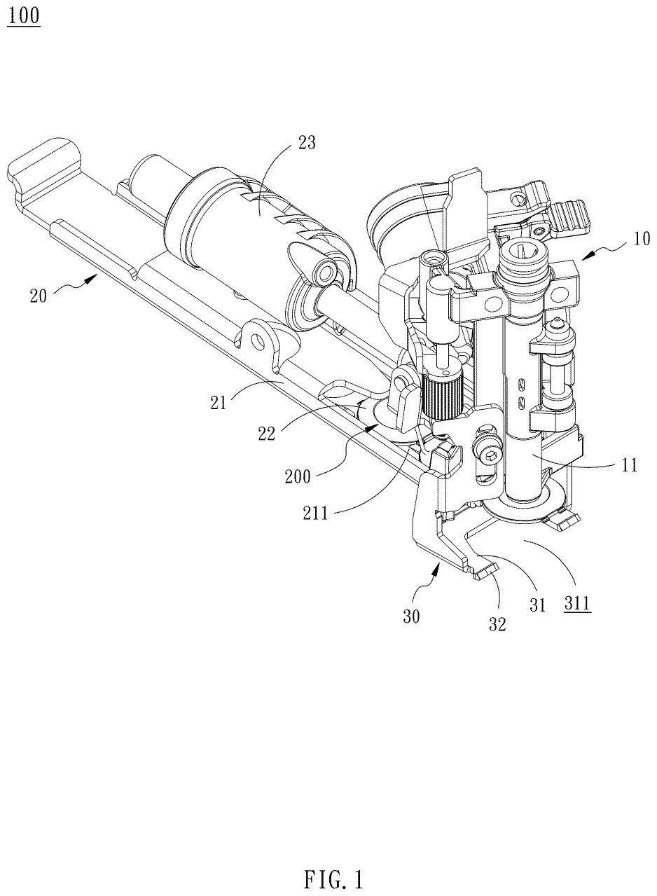

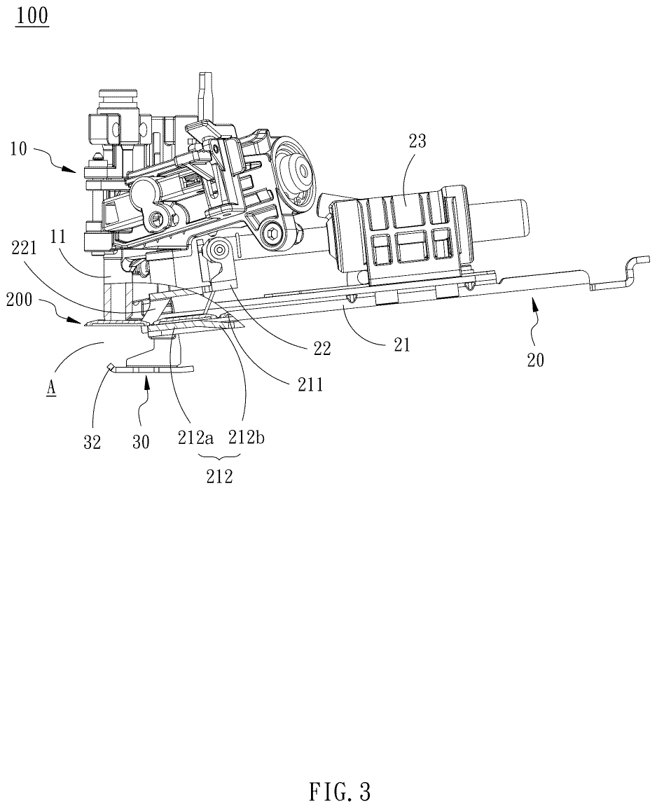

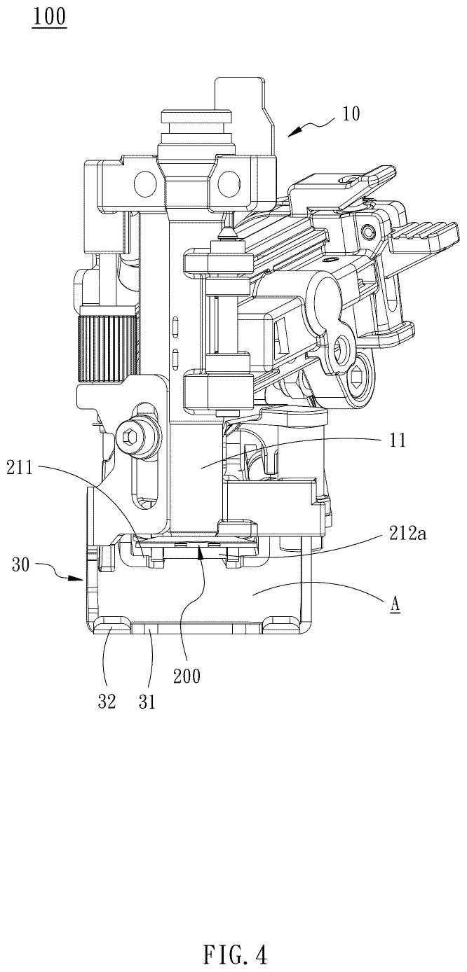

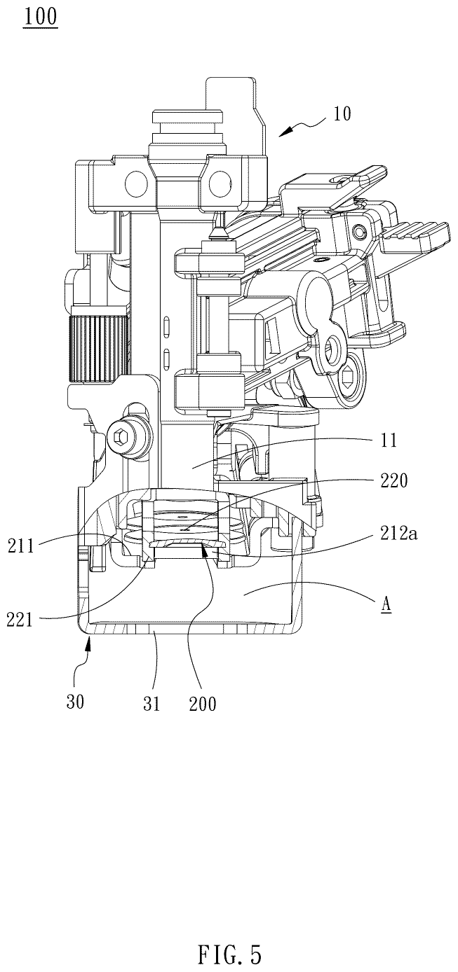

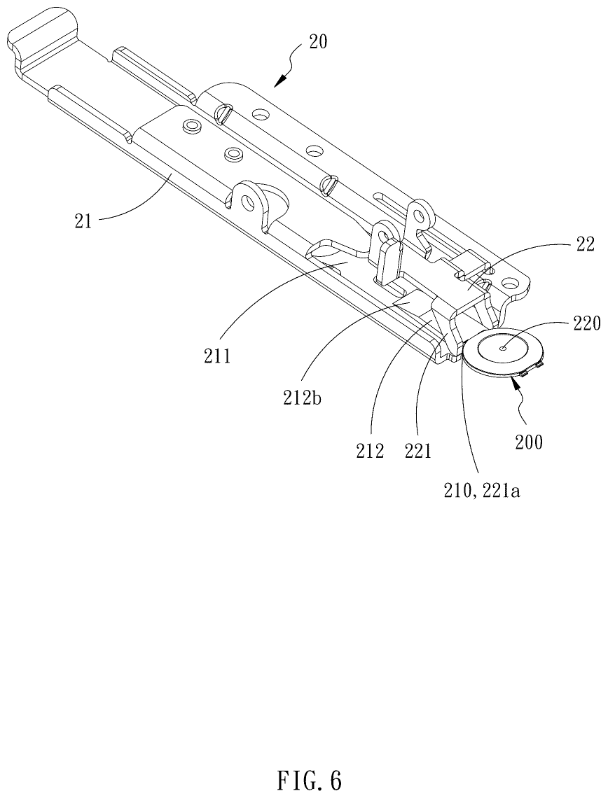

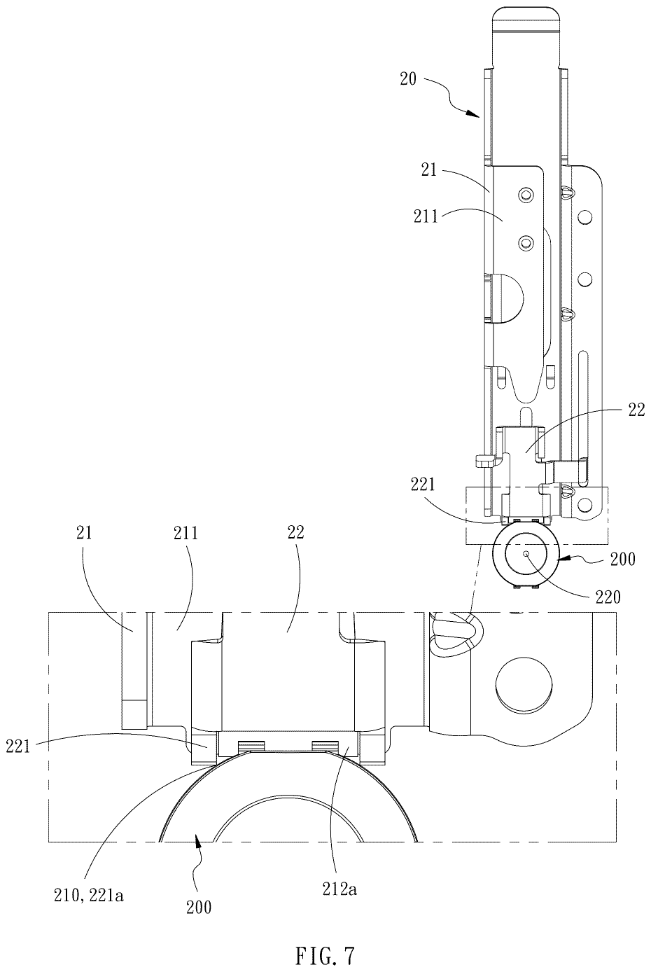

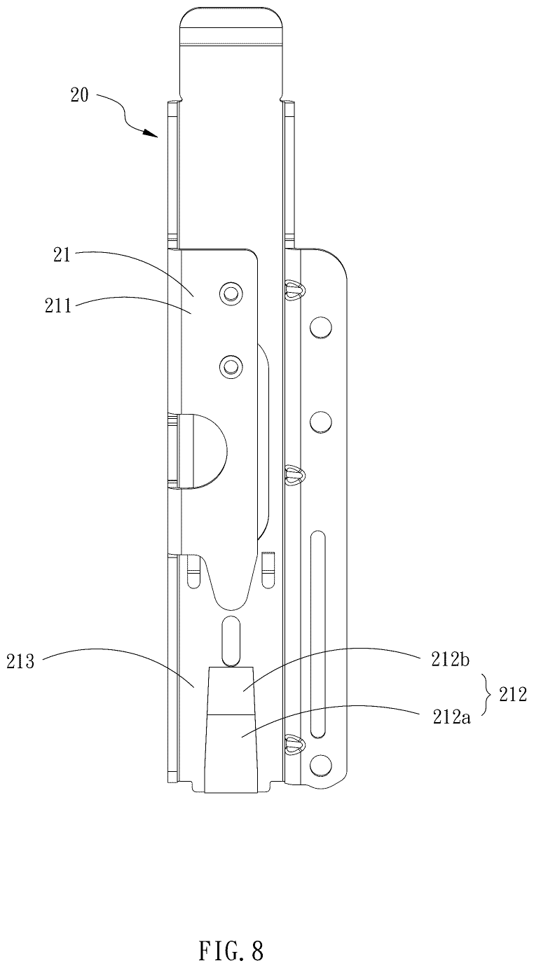

Referring to FIG. 1 to FIG. 8, a nail gun 100 with washer positioning structure in accordance with an embodiment of the present disclosure, comprising a gun body 10, a conveyor device 20, and a supporting member 30. Therein, the present disclosure is applied to fire nails (not shown) for securing a to-be-secured object (not shown), with a washer 200 fixed between the nail and the to-be-secured object, so that the contact area originally between the nail and the to-be-secured object is increased through the washer 200, such that the nail secures the to-be-secured object more stably.

The gun body 10 comprises a firing part 11 and is located above an operation area A, wherein the firing part 11 fires the nails to the operation area A.

The conveyor device 20 conveys the plurality of washers 200 to the operation area A. the conveyor device 20 comprises a conveying member 21 and a blocker 22. The conveying member 21 comprises a concave conveying groove 211. The washers 200 are placed in the conveying groove 211 along a length direction X of the conveying member 21. The conveying groove 211 comprises a guidance supporting part 212 convexly disposed along a height direction Y perpendicular to the length direction X. The guidance supporting part 212 is disposed on an end of the conveying groove 211 is adjacent to the operation area A. The guidance supporting part 212 comprises a supporting section 212a protruding toward the operation area A along the length direction X. The guidance supporting part 212 comprises a guiding section 212b on one end thereof away from the operation area A. The blocker 22 comprises two blocking parts 221 disposed between the washer 200 located in the operation area A and the washer 200 located at the guidance supporting part 212.

Referring to FIG. 1 to FIG. 8, in the embodiment, a recess part 213 is formed between the periphery of the supporting section 212a and the conveying groove 211. Each blocking part 221 is disposed in the recess part 213. Further, each blocking part 221 comprises a first blocking portion 221a, and a second blocking portion 210 is disposed on the periphery of the washer 200 located in the operation area A, wherein the first blocking portion 221a and the second blocking portion 210 abut against each other. Therefore, through the connection relationship of the plurality of washers 200, the support provided by the supporting section 212a, and the abutting relationship between the washer 200 and the blocking part 221, the washer 200 located in the operation area A is effectively positioned in the operation area A, preventing the washer 200 from displacement during the securing process of the to-be-secured object, allowing the nail and the washer 200 to be accurately secured on the to-be-secure object.

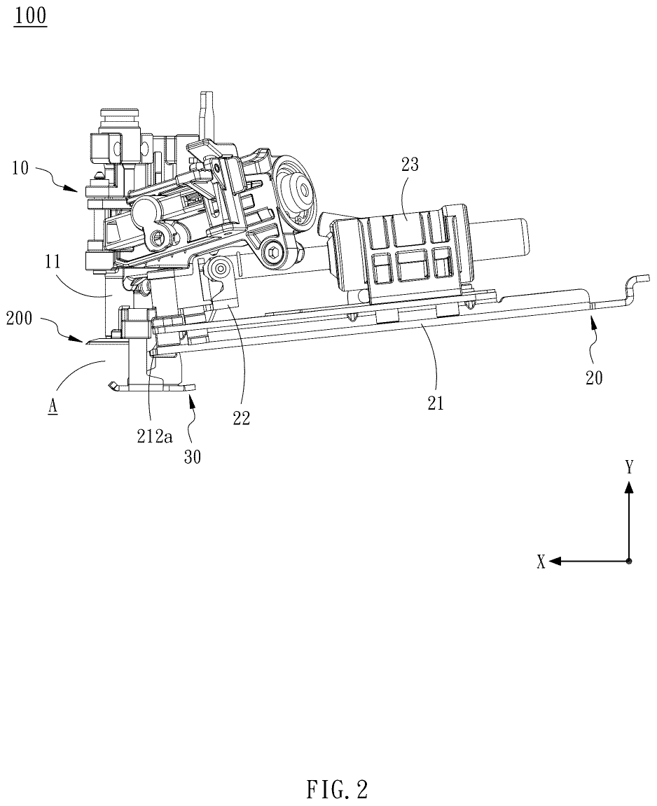

Referring to FIG. 2 to FIG. 8, in the embodiment, the height of the guiding section 212b expands toward the operation area A, the width of the guidance supporting part 212 expands toward the operation area A, and the conveying member 21 is inclined with respect to the ground. With such configuration, the inclined structure of the conveying member 21 and the expansion structure of the guidance supporting part 212 enable the washer 200 to be conveyed to the operation area A more easily, so as to lower the chance of the conveyance failure of the washer 200. Moreover, the expansion structure of the guidance supporting part 212 also enables the washer 200 to be positioned in the operation area A more stably.

Referring to FIG. 1 to FIG. 5, in the embodiment, the blocker 22 is pivotally connected with a driving member 23. The driving member 23 controls the blocker 22 to be optionally placed between the washer 200 located in the operation area A and the washer 200 located at the guidance supporting part 212. Therefore, the driving member 23 controls the pivoting position of the blocker 22, so as to ensure that only one washer 200 is located in the operation area A, thereby preventing the washer 200 or the nail from displacement, which causes the securing process failure of the to-be-secured object.

The supporting member 30 is disposed in the operation area A. The supporting member 30 comprises a position limiting groove 31 concavely disposed on the bottom of the supporting member 30. The position limiting groove 31 defines a fixing position 311. The firing part 11 fixes the nail and the washer 200 in the operation area A at the fixing position 311, whereby the to-be-secured object at the fixing position 311 is accordingly secured by the nail and the washer 200.

Referring to FIG. 1 to FIG. 5, in the embodiment, a hook part 32 is disposed on two opposite sides of the position limiting groove 31. The hook part 32 prevents the supporting member 30 and the to-be-secured object from damaging the structure of the to-be-secured object due to an excessive friction during the movement of the supporting member 30.

Referring to FIG. 1 to FIG. 8, in the embodiment, each washer 200 has a fixing part 220 at the center thereof for the nail to pass therethrough. Therefore, when the to-be-secured object is to be secured, the nail passes through the fixing part 220 (the center of the washer 200) to stably secure the to-be-secured object.

With such configuration, through the connection relationship of the plurality of washers 200, the support provided by the supporting section 212a, and the abutting relationship between the washer 200 and the blocking part 221, the washer 200 located in the operation area A is effectively positioned in the operation area A, preventing the washer 200 from displacement during the securing process of the to-be-secured object, allowing the nail and the washer 200 to be accurately secured on the to-be-secure object.

Although particular embodiments of the disclosure have been described in detail for purposes of illustration, various modifications and enhancements may be made without departing from the spirit and scope of the disclosure. Accordingly, the disclosure is not to be limited except as by the appended claims.

1. A nail gun with washer positioning structure, comprising:
a gun body having a firing part and located above an operation area, the firing part configured to fire a nail to the operation area;
a conveyor device configured to convey a plurality of washers to the operation area, the conveyor device having a conveying member and a blocker, the conveying member comprising a concave conveying groove, the washers placed in the conveying groove along a length direction of the conveying member, the conveying groove comprising a guidance supporting part convexly disposed along a height direction perpendicular to the length direction, the guidance supporting part disposed on one end of the conveying groove is adjacent to the operation area, the guidance supporting part having a supporting section protruding toward the operation area along the length direction, the guidance supporting part having a guiding section disposed on one end thereof away from the operation area, the blocker having two blocking parts positioned between the washer located in the operation area and the washer located at the guidance supporting part; and
a supporting member disposed in the operation area, the supporting member having a position limiting groove concavely disposed on a bottom part of the supporting member, the position limiting groove defining a fixing position, such that the firing part fixes the nail and the washer in the operation area at the fixing position,
wherein a height of the guiding section expands toward the operation area,
wherein a width of the guidance supporting part expands toward the operation area.

2. The nail gun of claim 1, wherein a recess part is formed between a periphery of the supporting section and the conveying groove, with each of the blocking parts disposed in the recess part.

3. The nail gun of claim 2, wherein each of the blocking parts has a first blocking portion, and a periphery of the washer in the operation area has a second blocking portion; the first blocking portion and the second blocking portion abut against each other.

4. (canceled)

5. (canceled)

6. The nail gun of claim 1, wherein the conveying member is inclined with respect to a ground.

7. The nail gun of claim 1, wherein each of the washers has a fixing part at a center thereof, and the nail passes through the fixing part.

8. The nail gun of claim 1, wherein the blocker is pivotally connected with a driving member; the driving member controls the blocker to be optionally placed between the washer located in the operation area and the washer located at the guidance supporting part.

9. The nail gun of claim 1, wherein a hook part is disposed on two opposite sides of the position limiting groove.
